(19) United States
(12) Patent Application Publication
(10) Pub. No.: US 2024/0031872 A1
(43) Pub. Date: Jan. 25, 2024

(54) BASE STATION, WIRELESS COMMUNICATION SYSTEM, WIRELESS COMMUNICATION METHOD, AND WIRELESS COMMUNICATION PROGRAM

(71) Applicant: NIPPON TELEGRAPH AND TELEPHONE CORPORATION, Tokyo (JP)

(72) Inventors: Masafumi YOSHIOKA, Musashino-shi, Tokyo (JP); Hayato FUKUZONO, Musashino-shi, Tokyo (JP); Keita KURIYAMA, Musashino-shi, Tokyo (JP); Takafumi HAYASHI, Musashino-shi, Tokyo (JP)

(73) Assignee: NIPPON TELEGRAPH AND TELEPHONE CORPORATION, Tokyo (JP)

(21) Appl. No.: 18/023,886

(22) PCT Filed: Sep. 3, 2020
(86) PCT No.: PCT/JP2020/033494

§ 371 Date: Feb. 28, 2023

(51) Int. Cl. H04W 28/18; H04L 1/00

(52) U.S. Cl. CPC H04W 28/18; H04L 1/0003

(57) ABSTRACT

A base station is wirelessly connected to each of a plurality of subscriber stations accommodating one or more terminals and includes a detection unit configured to detect at least one of a change in the number of terminals in communication accommodated by each of the subscriber stations and a change in a radio wave environment with each of the subscriber stations; and a setting unit configured to set a modulation scheme of a minimum modulation order in which a total communication amount of all the terminals that perform communication is accommodatable for each of the subscriber stations in each of the subscriber stations based on the change detected by the detection unit and to set weighting of radio wave intensity in each of the subscriber stations so that communication quality in the modulation scheme of the minimum modulation order is maximized.

### TECHNICAL FIELD

The present invention relates to a base station, a radio communication system, a radio communication method and a radio communication program.

### BACKGROUND ART

In a subscriber system radio communication system, for example, a plurality of subscriber stations each accommodating a plurality of voice lines (terminals) and a base station connected to a network realize voice communication for a plurality of simultaneously generated calls by performing radio communication (radio connection).

For example, NPL 1 discloses an overview of a radio interface protocol architecture. Further, NPL 2 discloses a method of specifying and evaluating quality parameters which a service provider takes into consideration.

In a digital radio system, a technology for changing a modulation order, such as quadrature phase shift keying (QPSK), 16 quadrature amplitude modulation (QAM), or 64 QAM, in accordance with signal to noise ratio (SNR) is known.

An equity or a necessary band is estimated and a band is allocated to each terminal. When the digital radio system performs voice communication, call quality is stabilized by lowering a modulation order while ensuring a required communication amount (or a bit rate) in a connection line with each terminal.

Furthermore, when one base station accommodates a plurality of terminals via a plurality of subscriber stations by using multiple input multiple output (MIMO), each terminal is generally equal and therefore radio wave intensity in a radio section becomes uniform.

### CITATION LIST

### Non Patent Literature

[NPL 1] 3rd Generation Partnership Project; Technical Specification Group Radio Access Network; Evolved Universal Terrestrial Radio Access (E-UTRA) and Evolved Universal Terrestrial Radio Access Network (E-UTRAN); Overall Description; Stage 2 (Release 12), 3GPP TS 36.300 V12.2.0 (2014-06)
[NPL 2] TTC Standard, Method of Evaluating Call Quality of IP Telephone, Aug. 25, 2008, Telecommunication Technology Committee, 5th Edition

### SUMMARY OF INVENTION

### Technical Problem

In a radio system, radio wave intensity in a radio section affects communication quality. In general, necessity of a communication capacity in each voice line (terminal) is different. Therefore, in the related art, a communication environment was conserved even for a terminal which did not perform communication, and communication was performed under an environment of low communication quality in a terminal in which communication often arose abundantly.

An objective of the present invention is to provide a base station, a radio communication system, a radio communication method, and a radio communication program capable of efficiently improving communication quality of all terminals even when a plurality of subscriber stations are involved.

### Solution to Problem

According to an aspect of the present invention, a base station wirelessly connected to each of a plurality of subscriber stations accommodating one or more terminals includes a detection unit configured to detect at least one of a change in the number of terminals in communication accommodated by each of the subscriber stations and a change in a radio wave environment with each of the subscriber stations; and a setting unit configured to set a modulation scheme of a minimum modulation order in which a total communication amount of all the terminals that perform communication is accommodatable for each of the subscriber stations in each of the subscriber stations based on the change detected by the detection unit and to set weighting of radio wave intensity in each of the subscriber stations so that communication quality in the modulation scheme of the minimum modulation order is maximized.

According to another aspect of the present invention, a radio communication system includes a plurality of subscriber stations each accommodating one or more terminals and a base station wirelessly connected to each of the subscriber stations. The radio communication system includes a detection unit configured to detect at least one of a change in the number of terminals in communication accommodated by each of the subscriber stations and a change in a radio wave environment with each of the subscriber stations; and a setting unit configured to set a modulation scheme of a minimum modulation order in which a total communication amount of all the terminals that perform communication is accommodatable for each of the subscriber stations in each of the subscriber stations based on the change detected by the detection unit and to set weighting of radio wave intensity in each of the subscriber stations so that communication quality in the modulation scheme of the minimum modulation order is maximized.

According to still another aspect of the present invention, a radio communication method is performed between a base station and each of a plurality of subscriber stations each accommodating one or more terminals. The method includes: a detection step of detecting at least one of a change in the number of terminals in communication accommodated by each of the subscriber stations and a change in a radio wave environment with each of the subscriber stations; and a setting step of setting a modulation scheme of a minimum modulation order in which a total communication amount of all the terminals that perform communication is accommodatable for each of the subscriber stations in each of the subscriber stations based on the change detected by the detection unit, and setting weighting of radio wave intensity in each of the subscriber stations so that communication quality in the modulation scheme of the minimum modulation order is maximized.

### Advantageous Effects of Invention

According to the present invention, communication quality of all terminals can be efficiently improved even when a plurality of subscriber stations are involved.

### BRIEF DESCRIPTION OF DRAWINGS

FIG. 1 is a diagram illustrating an exemplary configuration of a radio communication system according to an embodiment.

FIG. 2 is a functional block diagram illustrating functions of a base station according to the embodiment.

FIG. 3 is a diagram illustrating an example of kinds and classification of functions of the base station according to the embodiment.

FIG. 4 is a diagram illustrating a radio throughput and the number of lines corresponding to a modulation scheme.

FIG. 5 is a flowchart illustrating an example of an operation when a base station according to the embodiment performs setting on each terminal via a subscriber station.

FIG. 6 is a diagram illustrating a state in which the radio communication system according to an embodiment performs communication.

FIG. 7 is a diagram illustrating a state of the radio communication system when a line state is changed.

FIG. 8 is a diagram illustrating an example of a hardware configuration of a base station according to the embodiment.

### DESCRIPTION OF EMBODIMENTS

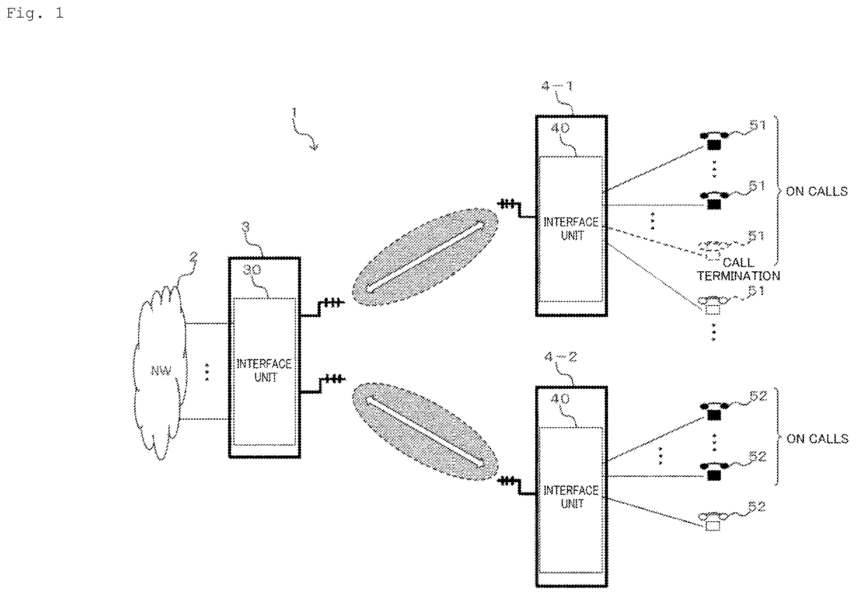

Hereinafter, an embodiment of a radio communication system will be described below with reference to the drawings. FIG. 1 is a diagram illustrating an exemplary configuration of a radio communication system 1 according to the embodiment. As illustrated in FIG. 1, the radio communication system 1 is a digital subscriber-based radio system that includes a base station 3 connected to a network 2 and a plurality of subscriber stations 4-1 and 4-2 performing radio communication using MIMO with the base station 3.

The radio communication system 1 accommodates a plurality of terminals (51 and 52) through, for example, voice lines, but the present invention is not limited thereto and data communication lines may be accommodated.

The base station 3 is a radio communication device in which an interface unit 30 provided therein is connected to the network 2 and has functions of a transmitter and a receiver. The interface unit 30 performs control such that a signal inside the base station 3 interfaces with a signal outside of the base station 3. The base stations 3 perform radio communication with the subscriber stations 4-1 and 4-2 using MIMO.

The subscriber station 4-1 is a radio communication device in which an interface unit 40 provided therein is connected to, for example, a plurality of terminals (telephone terminals) 51 and has functions of a transmitter and a receiver. The interface unit 40 performs control such that a signal inside the subscriber station 4-1 interfaces with a signal outside the subscriber station 4-1. Then, the subscriber station 4-1 relays two-way communication between the base station 3 and the plurality of terminals 51.

The subscriber station 4-2 is a radio communication device in which an interface unit 40 provided therein is connected to, for example, a plurality of terminals (telephone terminals) 52 and has functions of a transmitter and a receiver. An interface unit 40 performs control such that a signal inside the subscriber station 4-2 interfaces with a signal outside the subscriber station 4-2. The subscriber station 4-2 relays communication between the base station 3 and the plurality of terminals 52.

Here, a state in which some of the plurality of terminals 51 accommodated by the subscriber station 4-1 are on calls simultaneously, and one terminal 51 terminates the call and the other terminals 51 are not on calls is illustrated as an example. In addition, a state in which some of the plurality of terminals 52 accommodated by the subscriber station 4-2 are on calls simultaneously and the other terminals 52 are not on calls is illustrated.

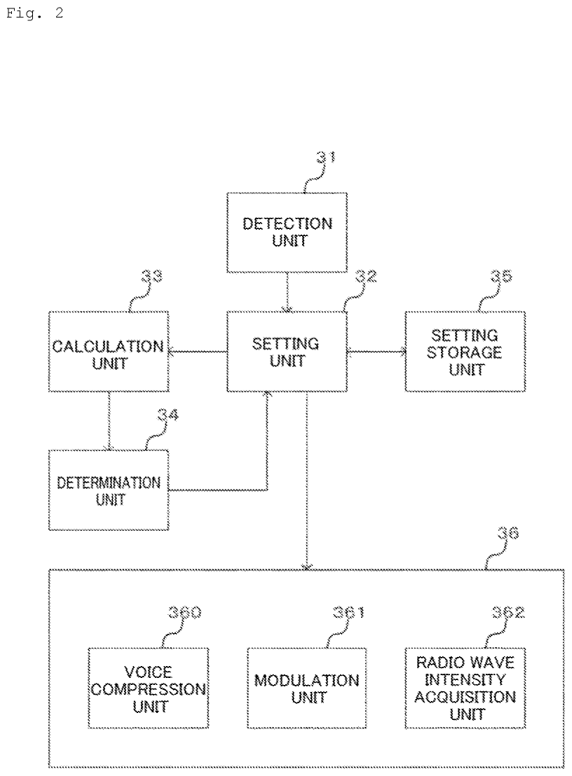

FIG. 2 is a functional block diagram illustrating functions of the base station 3 according to an embodiment. As illustrated in FIG. 2, the base station 3 includes a detection unit 31, a setting unit 32, a calculation unit 33, a determination unit 34, a setting storage unit 35, and a processing unit 36 in addition to the above-described functions.

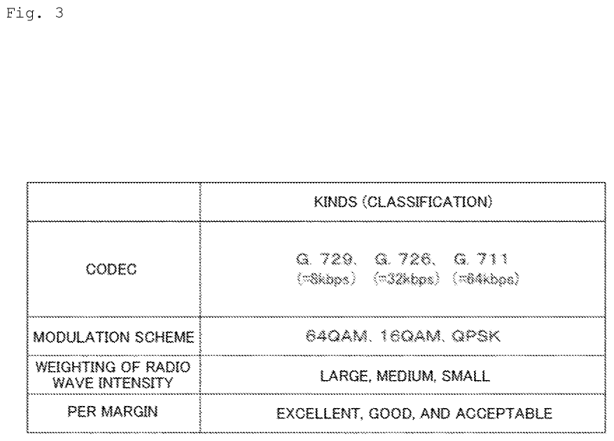

First, a function of the processing unit 36 will be described. As illustrated in FIG. 2, the processing unit 36 includes a voice compression unit 360, a modulation unit 361, and a radio wave intensity adjustment unit 362 and performs processing to switch the plurality of functions illustrated in FIG. 3.

The voice compression unit 360 perform processing for compressing the voice signal, for example, using any codec of G.729 (=8 kbps), G.726 (=32 kbps), and G.711 (=64 kbps). That is, the voice compression unit 360 compresses the voice signal by using any of a plurality of codecs having different compression rates (bit rates).

The modulation unit 361 performs processing for modulating (adaptively modulating) a transmission signal, for example, using any one of 64QAM in which one symbols has 64 values, 16QAM in which one symbol has 16 values or QPSK in which one symbol has 4 values. That is, the modulation unit 361 modulates a transmission signal using any one of a plurality of modulation schemes that have different amounts of information per symbol and tolerance to noise and waveform distortion.

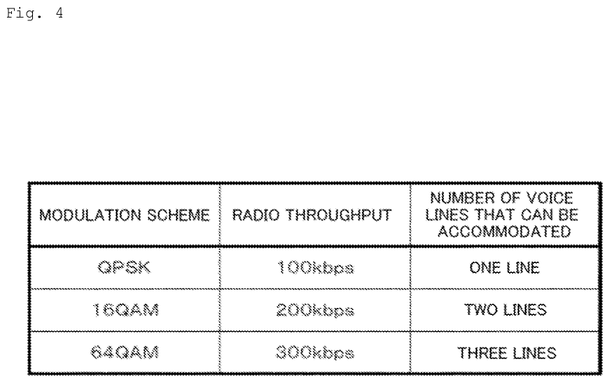

It is assumed that, for example, the radio throughput illustrated in FIG. 4 and the number of voice lines which can be accommodated are determined in a modulation scheme by which the modulation unit 361 performs modulation. For example, in the case of modulation by QPSK, the radio throughput is 100 kbps, and the number of voice lines which can be accommodated while satisfying required quality is one. In the case of modulation by 16QAM, the radio throughput is 200 kbps, and the number of voice lines which can be accommodated while satisfying required quality is two. In the case of modulation by 64QAM, the radio throughput is 300 kbps, and the number of voice lines which can be accommodated while satisfying required quality is three.

These modulation schemes have a characteristic that when the order of the modulation scheme is lowered, the communication quality is improved although the number of lines which can be accommodated while satisfying the required quality is reduced. When the radio throughput is excessively large with respect to the required throughput of the line in high SNR/high-order modulation (64QAM or the like), it is preferable to lower the modulation order to low-order modulation (QPSK or the like) and stabilize communication quality at a high level. The modulation schemes are distinguished in accordance with, for example, a modulation index.

The radio wave intensity adjustment unit 362 (see FIG. 2) adjusts radio wave intensity of a signal to be transmitted to each of the subscriber stations 4-1 and 4-2 in accordance with weighting of radio wave intensity distinguished at, for example, 3 stages (large, medium, and small).

Here, as illustrated in FIG. 3, the transmission radio waves processed by the processing unit 36 are classified into excellent, good, and acceptable types in accordance with a magnitude of a packet error rate (PER) margin. It is assumed that, for example, a SNR/PER change for a predetermined time is detected and determined and the PER margin is, for example, a margin to required quality such as an R value (a total call quality index: rating factor).

In order for the processing unit 36 to perform the above-described processing, the detection unit 31 illustrated in FIG. 2 detects at least one of a change in the number of terminals accommodated by each of the subscriber stations 4-1 and 4-2 during communication and a change in a radio wave environment between the subscriber stations 4-1 and 4-2, and outputs a detection result to the setting unit 32.

For example, when at least one of the terminals 51 and 52 accommodated by the subscriber station 4-1 and 4-2 initiates or terminates a call and a radio wave environment (communication environment) between the base station 3 and the subscriber stations 4-1 and 4-2 changes considerably, the detection unit 31 detects necessity that the setting unit 32 changes setting to be described below.

The setting unit 32 sets a modulation scheme of a minimum modulation order in which a total communication amount of all the terminals that perform communication is accommodatable for each subscriber station in each of the subscriber stations 4-1 and 4-2 based on the change detected by the detection unit 31. The setting unit 32 sets weighting of radio wave intensity in each of the subscriber stations 4-1 and 4-2 so that communication quality in the modulation scheme of the minimum modulation order is maximized.

For example, when the setting unit 32 performs setting on the processing unit 36, the setting unit 32 first temporarily sets a codec with a lowest compression rate (a bit rate) in all the terminals, temporarily sets a modulation scheme and radio wave intensity in the subscriber stations 4-1 and 4-2, and outputs setting information to the calculation unit 33.

The calculation unit 33 calculates the number of accommodated lines and a PER margin in a case in which the codec for each terminal, and the modulation scheme and the radio wave intensity for the subscriber stations 4-1 and 4-2 are set, and outputs the calculation result to the determination unit 34.

The determination unit 34 determines whether the number of accommodated lines and the PER margin are sufficiently necessary, and outputs a determination result to the setting unit 32.

Subsequently, the setting unit 32 stores setting information indicating the codec, the modulation scheme, and the radio wave intensity in the setting storage unit 35 in accordance with the determination result of the determination unit 34. For example, when the PER margin is sufficient, the setting unit 32 performs setting so that a compression rate (a bit rate) of the codec for some or all of the terminals is increased and outputs the setting information to the calculation unit 33 again. For example, when the PER margin is not sufficient, the setting unit 32 reads the setting information with highest quality at which the PER margin is sufficient (a required condition is satisfied) from the setting information stored in the setting storage unit 35, and performs setting on the processing unit 36.

The setting unit 32 has a function of performing setting so that a bit rate of communication performed by all the terminals is equally close for each subscriber station. The setting unit 32 is assumed to have a function of setting weighting of the radio wave intensity in each of the subscriber stations 4-1 and 4-2 so that the margin for the required communication quality is equally close between the subscriber stations.

That is, the setting unit 32 realizes the setting in each of the subscriber stations 4-1 and 4-2 and the terminals 51 and 52 by performing the setting in the processing unit 36.

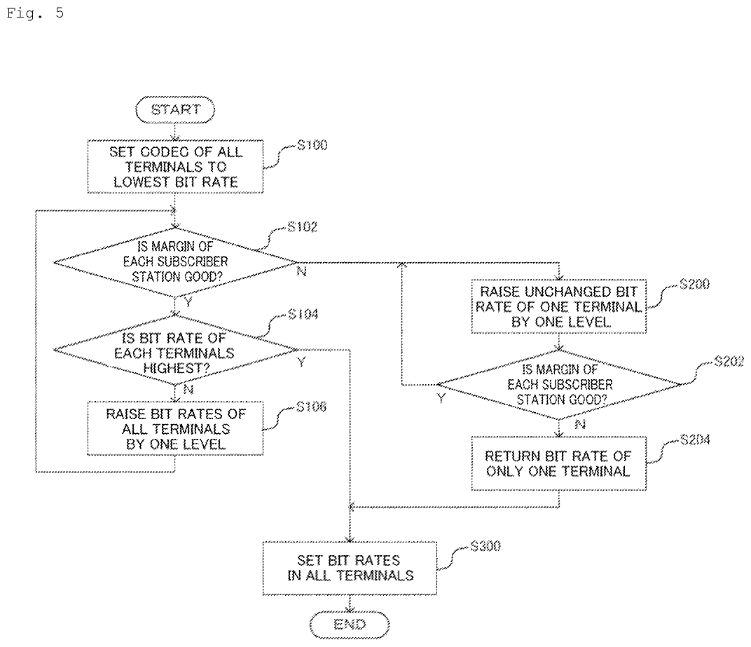

FIG. 5 is a flowchart illustrating an example of an operation when the base station 3 performs setting in each of the terminals 51 and 52 via the subscriber stations 4-1 and 4-2. The flowchart illustrated in FIG. 5 is an operation executed by the base station 3, for example, when the number of lines accommodated by one of the subscriber stations 4-1 and 4-2 during communication (the number of terminals on calls) is changed or a radio wave environment between the base station 3 and the subscriber stations 4-1 and 4-2 is considerably changed.

As illustrated in FIG. 5, for example, the base station 3 sets the codec of all the terminals to a lowest bit rate (S100).

Subsequently, the base station 3 determines whether the PER margin of each of the subscriber stations 4-1 and 4-2 is good (each subscriber station) is good (S102). Here, it is assumed that the PER margin is good in a case in which each of the subscriber stations 4-1 and 4-2 can accommodate a required number of lines in the modulation scheme, and the PER margin is equally close between the subscriber stations at the set radio wave intensity and thus is sufficient.

When the PER margin of each of the subscriber stations 4-1, 4-2 is good (Yes in S102), the base station 3 causes the processing to proceed to S104. When the PER margin is not good (No in S102) the processing proceeds to S200.

Subsequently, the base station 3 determines whether the bit rate of each terminal is the highest (S104). When the bit rate is the highest (Yes in S104), the processing proceeds to S300. When the bit rate is not the highest (No in S104), the processing proceeds to S106.

In the processing of S106, the base station 3 performs processing for raising the bit rates of all terminals by one level and returns the processing to S102. For example, when the codecs of all the terminals are G.729, the base station 3 performs processing for changing the codecs to G.726.

In the processing of S200, the base station 3 raises the bit rate by one level for one terminal of which the bit rate has not been changed among all the terminals.

Subsequently, the base station 3 determines whether the PER margin of each of the subscriber stations 4-1 and 4-2 is good (S202). Then, when the PER margin of each of the subscriber stations 4-1 and 4-2 is good (Yes in S202), the base station 3 returns the processing to S202. When the PER margin is not good (No in S202), the processing proceeds to S204.

In the processing of S204, the base station 3 returns the bit rate only for one terminal and advances to the processing of S300. For example, when the codec of the terminal of which the bit rate is raised is G.726 in the process of S200, the base station 3 performs processing for returning the codec of only the terminal to G.729.

In the processing of step S300, the base station 3 sets the bit rate in all the terminals. That is, the base station 3 collectively changes the bit rates of all the terminals in the processing of S100 to S106, changes the bit rates of the terminals one by one in the processing of S200 to S204, and finally sets the bit rates for all the terminals (all the terminals 51 and 52) in the processing of S300.

In the example of the operation illustrated in FIG. 5, it is assumed that each line (each terminal) is equally weighted. For example, when importance of a specific terminal is higher than importance of the other terminals, the base station 3 may arbitrarily adjust weighting of radio wave intensity, a modulation scheme, and the codec to efficiently improve communication quality of all the terminals in accordance with the importance.

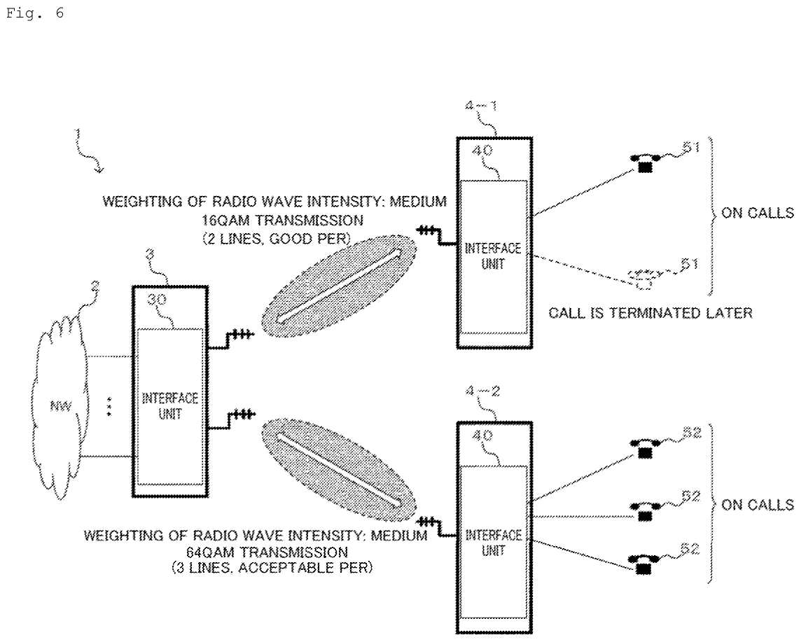

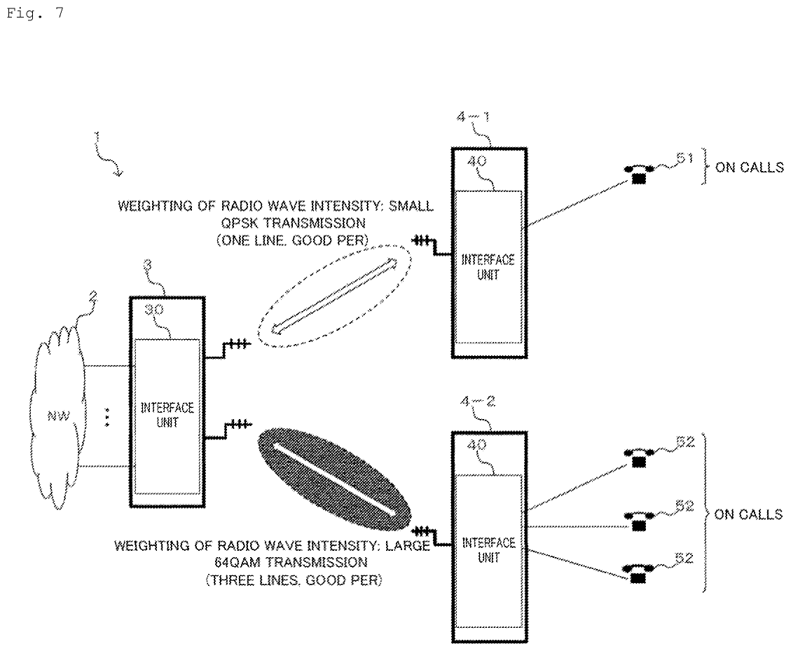

Next, an example of all the operations of the radio communication system 1 will be described. FIG. 6 is a diagram illustrating a state in which the radio communication system 1 performs communication. FIG. 7 is a diagram illustrating a state of the radio communication system 1 when a line state changes from the state illustrated in FIG. 6. In the example illustrated in FIGS. 6 and 7, it is assumed that the codecs of the terminals are the same.

As illustrated in FIG. 6, in the radio communication system 1, the subscriber station 4-1 accommodates, for example, two terminals 51 on calls, and one of the terminals 51 terminates the call later. Further, the subscriber station 4-2 accommodates, for example, three terminals 52 on calls.

At this time, the base station 3 sets “medium” as weighting of the radio wave intensity and performs radio communication with the subscriber station 4-1 in accordance with the modulation scheme of 16QAM. As illustrated in FIG. 4, in the case of 16QAM, two voice lines can be accommodated. It is also assumed that the PER margin in this case is classified as “good.”

The base station 3 sets “medium” as weighting of radio wave intensity and performs radio communication with the subscriber station 4-2 in accordance with the modulation scheme of 64QAM. As illustrated in FIG. 4, in the case of 64QAM, three voice lines can be accommodated. It is also assumed that the PER margin in this case is classified as “acceptable.”

Thereafter, when one of the terminals 51 accommodated by the subscriber station 4-1 terminates the call, the number of the terminals 51 accommodated by the subscriber station 4-1 during the call is one.

FIG. 7 is a diagram illustrating a state of the radio communication system 1 after one of the terminals 51 accommodated by the subscriber station 4-1 terminates the call.

In FIG. 7, the radio communication system 1 accommodates only one terminal 51 with which the subscriber station 4-1 is performing the call, and it is not necessary to allocate a communication capacity to the terminal 51 terminating the call. The subscriber station 4-2 remains accommodating three terminals 52 on calls.

At this time, the base station 3 performs processing so that “small” is set as weighting of the radio wave intensity and radio communication is performed with the subscriber station 4-1 in accordance with the modulation scheme of QPSK. As illustrated in FIG. 4, in the case of QPSK, one voice line can be accommodated. Further, the PER margin in this case is classified as “good” and the communication quality does not deteriorate. even when the radio wave intensity is weakened.

The base station 3 performs processing so that “large” is set as weighting of radio wave intensity and radio communication is performed with the subscriber station 4-2 in accordance with the modulation scheme of 64QAM. As illustrated in FIG. 4, in the case of 64QAM, three voice lines can be accommodated, but the base station 3 raises the weighting of the radio wave intensity to improve the PER margin to a state in which the PER margin is classified into “good.”

In this way, in the radio communication system 1, the base station 3 sets the weighting of the radio wave intensity in each of the subscriber stations 4-1 and 4-2. Therefore, the communication quality of all the terminals can be efficiently improved even when the plurality of subscriber stations are used.

The radio communication system 1 can set and accommodate all the terminals in the codec of the bit rate equally close for each subscriber station and can change the weighting of the radio wave intensity between the base station 3 and the subscriber stations 4-1 and 4-2 so that the PER margin is almost the same between the subscriber stations.

Some or all of the functions of the base station 3 may be configured with hardware such as a programmable logic device (PLD) or a field programmable gate array (FPGA) or may be configured as a program that is executed by a processor such as a CPU. Other devices such as the subscriber station 4-1 and 4-2 may have the functions of the base station 3.

The base station 3 according to the present invention can be implemented using a computer and a program, and the program can be recorded on a recording medium or provided via a network.

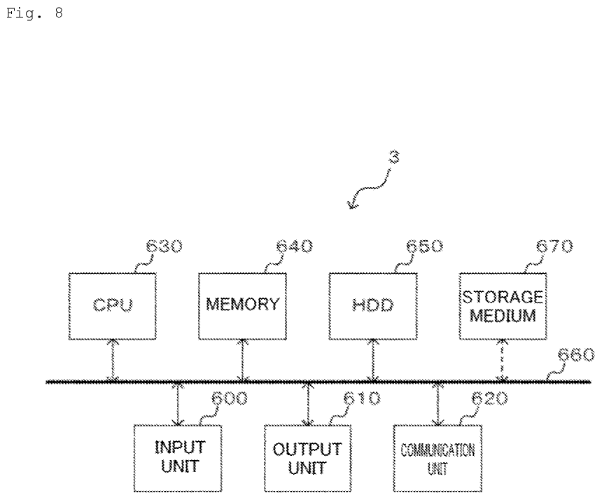

FIG. 8 is a diagram illustrating an example of a hardware configuration of the base station 3 according to an embodiment. As illustrated in FIG. 8, for example, the base station 3 has a function of a computer in which an input unit 600, an output unit 610, a communication unit 620, a CPU 630, memory 640, and an HDD 650 are connected via a bus 660. The base station 3 is configured to be able to input and output data to and from a computer-readable recording medium 670.

The input unit 600 is, for example, a keyboard, a mouse, and the like. The output unit 610 is, for example, a display device such as a display. The communication unit 620 is, for example, a radio network interface.

The CPU 630 controls each unit of the base station 3 and performs predetermined processing or the like. The memory 640 and the HDD 650 are storage units that store data or the like.

The recording medium 670 can store a program or the like that executes the functions of the base station 3. An architecture of the base station 3 is not limited to the example illustrated in FIG. 8.

Although embodiments of the present invention have been described above with reference to the drawings, it is apparent that the above-described embodiments are merely exemplary illustrations of the present invention and the present invention is not limited to the above-described embodiments. Accordingly, additions, omissions, substitutions, and other modifications of the components may be made within a scope that does not depart from the technical spirit and scope of the present invention.

### REFERENCE SIGNS LIST

1 Radio communication system
2 Network
3 Base station
4-1, 4-2 Subscriber station
30 Interface unit
31 Detection unit
32 Setting unit
33 Calculation unit
34 Determination unit
35 Setting storage unit
36 Processing unit
40 Interface unit
51 Terminal
52 Terminal
360 Voice compression unit
361 Modulation unit
362 Radio wave intensity adjustment unit
600 Input unit
610 Output unit
620 Communication unit
630 CPU
640 Memory
650 HDD
660 Bus
670 Storage medium

1. A base station wirelessly connected to each of a plurality of subscriber stations accommodating one or more terminals, the base station comprising:
a processor; and
a storage medium having computer program instructions stored thereon, when executed by the processor, perform to:
detect at least one of a change in the number of terminals in communication accommodated by each of the subscriber stations and a change in a radio wave environment with each of the subscriber stations; and
set a modulation scheme of a minimum modulation order in which a total communication amount of all the terminals that perform communication is accommodatable for each of the subscriber stations in each of the subscriber stations based on the change and to set weighting of radio wave intensity in each of the subscriber stations so that communication quality in the modulation scheme of the minimum modulation order is maximized.

2. The base station according to claim 1, wherein the computer program instructions further performs setting so that bit rates of communication performed by all the terminals are equally close for each of the subscriber stations.

3. The base station according to claim 1, wherein the computer program instructions further the setting unit sets the weighting of the radio wave intensity in each of the subscriber stations so that a margin for required communication quality is equally close between the subscriber stations.

4. A radio communication system including a plurality of subscriber stations each accommodating one or more terminals and a base station wirelessly connected to each of the subscriber stations, the radio communication system comprising:
a processor; and
a storage medium having computer program instructions stored thereon, when executed by the processor, perform to:
detect at least one of a change in the number of terminals in communication accommodated by each of the subscriber stations and a change in a radio wave environment with each of the subscriber stations; and
set a modulation scheme of a minimum modulation order in which a total communication amount of all the terminals that perform communication is accommodatable for each of the subscriber stations in each of the subscriber stations based on the change detected by the detection unit and to set weighting of radio wave intensity in each of the subscriber stations so that communication quality in the modulation scheme of the minimum modulation order is maximized.

5. A radio communication method performed between a base station and each of a plurality of subscriber stations each accommodating one or more terminals, the method comprising:
a detection step of detecting at least one of a change in the number of terminals in communication accommodated by each of the subscriber stations and a change in a radio wave environment with each of the subscriber stations; and
a setting step of setting a modulation scheme of a minimum modulation order in which a total communication amount of all the terminals that perform communication is accommodatable for each of the subscriber stations in each of the subscriber stations based on the detected change, and setting weighting of radio wave intensity in each of the subscriber stations so that communication quality in the modulation scheme of the minimum modulation order is maximized.

6. The radio communication method according to claim 5, wherein, in the setting step, bit rates of communication performed by all the terminals are equally close for each of the subscriber stations.

7. The radio communication method according to claim 5, wherein, in the setting step, the weighting of the radio wave intensity in each of the subscriber stations is set so that a margin for required communication quality is equally close between the subscriber stations.

8. A non-transitory computer-readable medium having computer-executable instructions that, upon execution of the instructions by a processor of a computer, cause the computer to function as the base station according to claim 1.
